(19) United States
(12) Patent Application Publication
(10) Pub. No.: US 2026/0066484 A1
(43) Pub. Date: Mar. 5, 2026

(54) ELECTRODE ASSEMBLY, SECONDARY BATTERY, AND BATTERY PACK

(71) Applicant: SAMSUNG SDI CO., LTD., Yongin-si (KR)

(72) Inventors: Jung Woo LEE, Suwon-si (KR); Jun Sun YONG, Suwon-si (KR); Kwang Soo BAE, Suwon-si (KR); Jun Hyung LEE, Suwon-si (KR); Ji Hwan KIM, Suwon-si (KR); Heyoung Cheoul ROH, Suwon-si, Gyeonggi-do (KR); Chae Eun BAE, Suwon-si (KR); Mi Sol KIM, Suwon-si (KR)

(21) Appl. No.: 19/063,506

(22) Filed: Feb. 26, 2025

(30) Foreign Application Priority Data
Aug. 28, 2024 (KR) 10-2024-0116105

(51) Int. Cl. H01M 50/533; H01M 10/0585; H01M 50/103; H01M 50/15; H01M 50/209; H01M 50/342

(52) U.S. Cl. CPC H01M 50/533; H01M 10/0585; H01M 50/103; H01M 50/15; H01M 50/209; H01M 50/3425

(57) ABSTRACT

An electrode assembly, including a first electrode, a second electrode facing the first electrode, a first tab member extending from the first electrode, and a second tab member extending from the second electrode, wherein the first electrode and the second electrode have shorter lengths parallel to a second direction intersecting a first direction than lengths parallel to the first direction.

### CROSS-REFERENCE TO RELATED APPLICATION

This application claims priority from and the benefit under 35 USC § 119 of Korean Patent Application No. 10-2024-0116105, filed on Aug. 28, 2024, in the Korean Intellectual Property Office, the entire disclosure of which is incorporated by reference for all purposes.

### BACKGROUND

### 1. Field

Embodiments relate to an electrode assembly, a secondary battery, and a battery pack.

### 2. Description of the Related Art

In general, recently, the demand for secondary batteries with high energy density and high capacity is rapidly increasing with the rapid supply of electronic devices using batteries, such as mobile phones, notebook computers, electric vehicles, and the like. Accordingly, research and development for improving the performance of lithium secondary batteries is being actively conducted.

A lithium secondary battery is a battery including a positive electrode and a negative electrode including active materials capable of intercalating and deintercalating lithium ions, and an electrolyte, and produces electrical energy due to oxidation and reduction reactions when lithium ions are intercalated/deintercalated into/from the positive electrode and the negative electrode.

The above-described information disclosed in the technology that forms the background of the present disclosure is provided to improve understanding of the background of the present disclosure, and thus may include information that does not constitute the related art.

### SUMMARY

Embodiments include an electrode assembly, including a first electrode, a second electrode facing the first electrode, a first tab member extending from the first electrode, and a second tab member extending from the second electrode, wherein the first electrode and the second electrode have shorter lengths parallel to a second direction intersecting a first direction than lengths parallel to the first direction.

The first tab member may extend from the first electrode in the first direction, and the second tab member may extend from the second electrode in the first direction.

The first tab member and the second tab member may be spaced apart from each other along the second direction.

Embodiments include a secondary battery, including a case including a vent, an electrode assembly accommodated in the case, the electrode assembly including a first tab member and a second tab member extending in a first direction, a cap assembly facing the electrode assembly along the first direction, the cap assembly including a first terminal and a second terminal, and a first connection member between the electrode assembly and the cap assembly, the first connection member connected to the first terminal and the first tab member, wherein the electrode assembly has a shorter length parallel to a second direction intersecting a first direction than a length parallel to the first direction.

The case may have a shorter length parallel to the second direction than a length parallel to the first direction.

The secondary battery may further include a guide portion between the case and the electrode assembly, the guide portion guiding a flow of gas toward the vent.

The guide portion may include first guide portions in the first direction, and a second guide portion in the second direction.

The first guide portions may be at both sides of the electrode assembly, and the second guide portion may face the vent.

Each of the first guide portions may include a first guide plate in contact with a side surface of the electrode assembly, and a pair of first guide side walls extending from the first guide plate, spaced apart from and facing each other, the pair of first guide side walls contacting the case.

The first guide portion may further include a first guide flow path between the pair of first guide side walls, and gas may flow through the first guide flow path.

The second guide portion may include a second guide plate in contact with a lower surface of the electrode assembly, and a pair of second guide side walls extending from the second guide plate, spaced apart from and facing each other, the pair of second guide side walls contacting the case.

The second guide portion may further include a second guide flow path between the pair of the second guide side walls, and gas may flow through the second guide flow path.

A through hole portion that communicates with the vent may be in the second guide plate.

The second guide portion may further include a reinforcement rib extending from the second guide plate, the reinforcement rib being between the pair of second guide side walls and in contact with the case.

The first connection member may include a first current collector connected to the first terminal, a first inner plate extending from the first current collector in the second direction, and a first outer plate extending from the first current collector in a direction opposite to the second direction.

The first tab member may include a first inner tab member connected to the first inner plate, and a first outer tab member spaced apart from the first inner tab member in the direction opposite to the second direction, the first outer tab member being connected to the first outer plate.

The secondary battery may further include a second connection member between the electrode assembly and the cap assembly, the second connection member being connected to the second terminal and the second tab member.

The second connection member may include a second current collector connected to the second terminal, a second inner plate extending from the second current collector in a direction opposite to the second direction, and a second outer plate extending from the second current collector in the second direction.

The first terminal and the second terminal may be spaced apart from each other along the second direction.

Embodiments include a battery pack, including a housing, and a plurality of secondary batteries disposed in the housing, wherein each of the plurality of secondary batteries has a shorter length parallel to a second direction intersecting a first direction than a length parallel to the first direction.

These and other aspects and features of the present disclosure will be described in or will be apparent from the following description of some embodiments of the present disclosure.

### BRIEF DESCRIPTION OF THE DRAWINGS

Features will become apparent to those of ordinary skill in the art by describing in detail exemplary embodiments with reference to the attached drawings, in which:

FIG. 1 is a perspective view schematically illustrating a configuration of a battery pack according to one or more embodiments of the present disclosure;

FIG. 2 is a perspective view schematically illustrating a configuration of a secondary battery according to one or more embodiments of the present disclosure;

FIG. 3 is an exploded perspective view schematically illustrating the configuration of the secondary battery according to one or more embodiments of the present disclosure;

FIG. 4 is a cross-sectional view schematically illustrating the configuration of the secondary battery according to one or more embodiments of the present disclosure;

FIG. 5 is a view schematically illustrating a configuration of an electrode assembly according to one or more embodiments of the present disclosure;

FIG. 6 is an enlarged cross-sectional view schematically illustrating a configuration of a cap assembly according to one or more embodiments of the present disclosure;

FIG. 7 is a perspective view schematically illustrating a configuration of a first guide portion according to one or more embodiments of the present disclosure;

FIG. 8 is a perspective view schematically illustrating a configuration of a second guide portion according to one or more embodiments of the present disclosure; and

FIG. 9 is a cross-sectional view schematically illustrating a flow of gas in the secondary battery according to one or more embodiments of the present disclosure.

### DETAILED DESCRIPTION

Example embodiments will now be described more fully hereinafter with reference to the accompanying drawings; however, they may be embodied in different forms and should not be construed as limited to one or more embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

The terms or words used in this specification and claims should not be construed as being limited to the usual or dictionary meaning and should be interpreted as meaning and concept consistent with the technical idea of the present disclosure based on the principle that the inventor can be his/her own lexicographer to appropriately define the concept of the term.

One or more embodiments described in this specification and the configurations shown in the drawings are provided as some example embodiments of the present disclosure and do not necessarily represent all of the technical ideas, aspects, and features of the present disclosure. Accordingly, it is to be understood that there may be various equivalents and modifications that may replace or modify one or more embodiments described herein at the time of filing this application.

It is to be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same or like elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B, and C,” “at least one of A, B, or C,” “at least one selected from a group of A, B, and C,” or “at least one selected from among A, B, and C” are used to designate a list of elements A, B, and C, the phrase may refer to any and all suitable combinations or a subset of A, B, and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It is to be understood that, although the terms “first,” “second,” “third,” etc. may be used herein to describe various elements, components, regions, layers, and/or sections, these elements, components, regions, layers, and/or sections are not to be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It is to be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (e.g., rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It is to be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all sub-ranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein.

References to two compared elements, features, etc. as being “the same” may mean that they are the same or substantially the same. Thus, the phrase “the same” or “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

When an arbitrary element is referred to as being arranged (or located or positioned) on the “above (or below)” or “on (or under)” a component, it may mean that the arbitrary element is placed in contact with the upper (or lower) surface of the component and may also mean that another component may be interposed between the component and any arbitrary element arranged (or located or positioned) on (or under) the component.

In addition, it is to be understood that when an element is referred to as being “coupled,” “linked,” or “connected” to another element, the elements may be directly “coupled,” “linked,” or “connected” to each other, or one or more intervening elements may be present therebetween, through which the element may be “coupled,” “linked,” or “connected” to another element. In addition, when a part is referred to as being “electrically coupled” to another part, the part may be directly electrically connected to another part or one or more intervening parts may be present therebetween such that the part and the another part are indirectly electrically connected to each other.

Throughout the specification, when “A and/or B” is stated, it means A, B, or A and B, unless otherwise stated. That is, “and/or” includes any or all combinations of a plurality of items enumerated. When “C to D” is stated, it means C or more and D or less, unless otherwise specified.

The terms used in the present specification are for describing embodiments of the present disclosure and are not intended to limit the present disclosure.

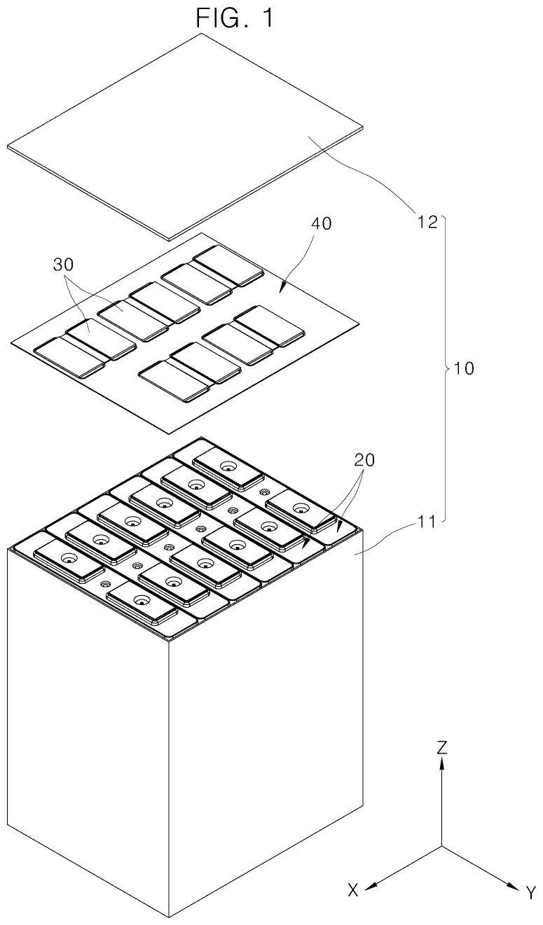

FIG. 1 is a perspective view schematically illustrating a configuration of a battery pack according to one or more embodiments of the present disclosure.

Referring to FIG. 1, the battery pack according to one or more embodiments may include a housing 10, a secondary battery 20, and a bus bar 30.

The housing 10 may form an approximate exterior of the battery pack and provide a space in which the secondary battery 20 may be accommodated.

The housing 10 according to one or more embodiments may include a housing body 11 and a cover 12.

The housing body 11 may be formed to have a shape of a box (e.g., quadrangle) in which the inside is empty and one side is open. However, a cross-sectional shape of the housing body 11 may be designed to have various shapes such as a polygonal shape, a circular shape, an oval shape, and the like.

The cover 12 may be coupled to the housing body 11 and close the inner space of the housing body 11. For example, the cover 12 may be formed to have a substantially plate shape and may be disposed to face the open side of the housing body 11.

The cover 12 may be fixed to the housing body 11 by various types of coupling methods such as bolting, welding, fitting, and the like.

The secondary battery 20 may function as a unit structure which stores and supplies power in the battery pack.

Hereinafter, the secondary battery 20 according to one or more embodiments of the present disclosure will be described.

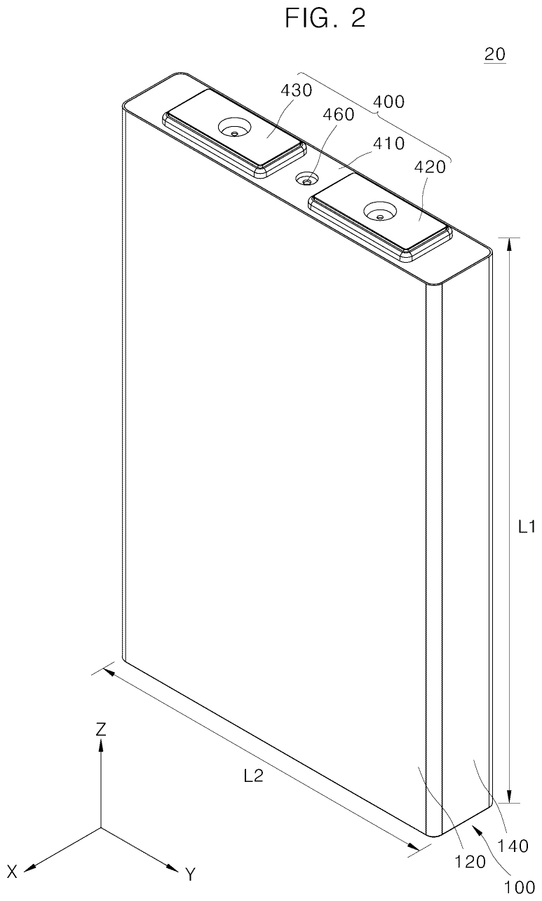

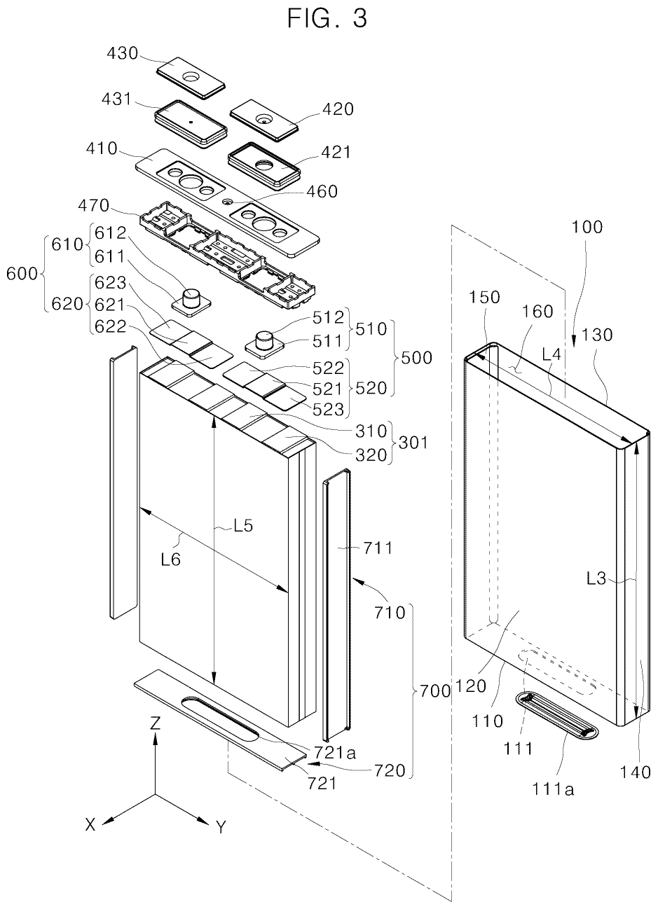

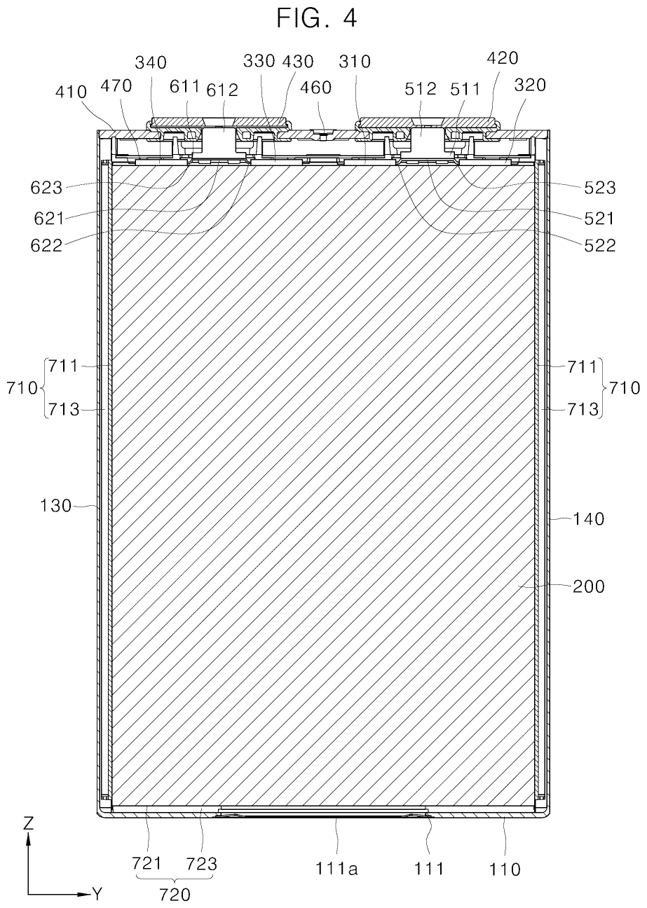

FIG. 2 is a perspective view schematically illustrating a configuration of the secondary battery according to one or more embodiments of the present disclosure, FIG. 3 is an exploded perspective view schematically illustrating the configuration of the secondary battery according to one or more embodiments of the present disclosure, and FIG. 4 is a cross-sectional view schematically illustrating the configuration of the secondary battery according to one or more embodiments of the present disclosure.

Hereinafter, an example in which the secondary battery 20 is a prismatic battery as a lithium-ion secondary battery will be described. However, the secondary battery 20 may be a lithium polymer battery or cylindrical battery.

Referring to FIGS. 2 to 4, the secondary battery 20 according to one or more embodiments may have a shorter length L2 parallel to a second direction intersecting a first direction than a length L1 parallel to the first direction. That is, the length L1 of the secondary battery 20 parallel to the first direction (e.g., the z-axis direction) may be formed longer than the length L2 of the secondary battery 20 parallel to the second direction (e.g., the y-axis direction).

Here, the first direction may mean a direction parallel to a Z-axis and a direction from a bottom portion 110 of the case 100 to be described below toward an opening 160 based on FIGS. 3 and 4. The second direction may mean a direction parallel to a Y-axis and a direction from a first side surface portion 140 of the case 100 toward a second side surface portion 150 based on FIGS. 3 and 4. A third direction may mean a direction parallel to an X-axis and a direction from a front surface portion 120 of the case 100 toward a rear surface portion 130 based on FIGS. 3 and 4.

The secondary battery 20 may include a case 100, an electrode assembly 200, a first tab member 301, a cap assembly 400, and a first connection member 500.

The case 100 may form an approximate exterior of the secondary battery 20 and accommodate the electrode assembly 200 therein.

The case 100 according to one or more embodiments may include the bottom portion 110, the front surface portion 120, the rear surface portion 130, the first side surface portion 140, and the second side surface portion 150.

The bottom portion 110 may form the exterior of a lower side (based on FIG. 3) of the case 100. The bottom portion 110 according to one or more embodiments may have a rectangular plate shape. The bottom portion 110 may be seated on the bottom surface of the housing body 11.

The front surface portion 120, the rear surface portion 130, the first side surface portion 140, and the second side surface portion 150 may form the exterior of the periphery of the case 100.

The front surface portion 120, the rear surface portion 130, the first side surface portion 140, and the second side surface portion 150 according to one or more embodiments may have plate shapes extending upward (in the z-axis direction) from the edges of the bottom portion 110 (based on FIG. 3).

The front surface portion 120, the rear surface portion 130, the first side surface portion 140, and the second side surface portion 150 may be disposed to surround the space above the bottom portion 110. The front surface portion 120, the rear surface portion 130, the first side surface portion 140, and the second side surface portion 150 may be disposed to form a rectangular cross-sectional shape.

The front surface portion 120 and the rear surface portion 130 may be disposed to face each other along a longitudinal direction of the housing 10. The front surface portion 120 and the rear surface portion 130 may be disposed to be parallel to each other. The areas of the front surface portion 120 and the rear surface portion 130 may be the same.

The first side surface portion 140 and the second side surface portion 150 may be disposed to face each other along a width direction (e.g., the y-axis direction) of the housing 10. The first side surface portion 140 and the second side surface portion 150 may be disposed parallel to each other.

The areas of the first side surface portion 140 and the second side surface portion 150 may be the same. The areas of the first side surface portion 140 and the second side surface portion 150 may be smaller than the areas of the front surface portion 120 and the rear surface portion 130.

The case 100 may further include the opening 160. The opening 160 according to one or more embodiments may mean a space surrounded by upper end portions of the front surface portion 120, the rear surface portion 130, the first side surface portion 140, and the second side surface portion 150. The opening 160 may interconnect the space inside and outside the case 100.

Accordingly, the case 100 according to one or more embodiments may have a rectangular parallelepiped shape with an open upper side (in the orientation shown).

The case 100 according to one or more embodiments may have a shorter length L4 parallel to the second direction (the width or y-axis direction) than a length L3 parallel to the first direction (the z-axis direction). That is, the length L3 of the case 100 parallel to the first direction may be formed longer than the length L4 of the case 100 parallel to the second direction.

The case 100 according to one or more embodiments may further include a vent hole 111 and a vent 111a.

The vent hole 111 may be provided in the bottom portion 110 of the case 100. The vent hole 111 may be formed to have a hole shape (e.g., an elongated oval shape as shown in FIG. 3) vertically passing through both surfaces of the bottom portion 110 in the first direction.

The vent hole 111 may function as a configuration providing a path through which flames, gas, smoke, or the like formed in the case 100 is discharged to the outside of the case 100 when thermal runaway of the secondary battery 20 occurs due to an overcurrent or the like. A cross-sectional shape of the vent hole 111 may be designed to have various shapes such as an oval shape, a circular shape, a polygonal shape, and the like.

The vent 111a is installed in the vent hole 111 and may be opened and closed in response to a change in internal pressure of the case 100. The vent 111a may prevent an electrolyte and the like in the case 100 from leaking out of the case 100 or moisture, foreign substances, and the like from entering the case 100 by closing the vent hole 111 when the secondary battery 20 normally operates.

The vent 111a may guide flames, gas, smoke, or the like formed inside the case 100 to be discharged to the outside of the case 100 by opening the vent hole 111 during the thermal runaway of the secondary battery 20.

The vent 111a according to one or more embodiments may be formed to have a substantially plate shape. The vent 111a may be fixed to the case 100 by various types of coupling methods such as welding, bolting, fitting, and the like.

The vent 111a may be disposed in the vent hole 111, or disposed to face the vent hole 111 at an upper or lower side of the bottom portion 110 along the first direction.

A thickness of the vent 111a parallel to the first direction may be smaller than a thickness of the bottom portion 110. Accordingly, the vent 111a may be easily ruptured or broken when the internal pressure of the case 100 increases.

The vent 111a may include a notch formed concavely toward the inside of the vent 111a so that the notch preferentially breaks when the internal pressure of the case 100 increases.

The electrode assembly 200 may function as a unit structure which performs charging and discharging operations of power in the secondary battery 20. The electrode assembly 200 may be accommodated in the case 100.

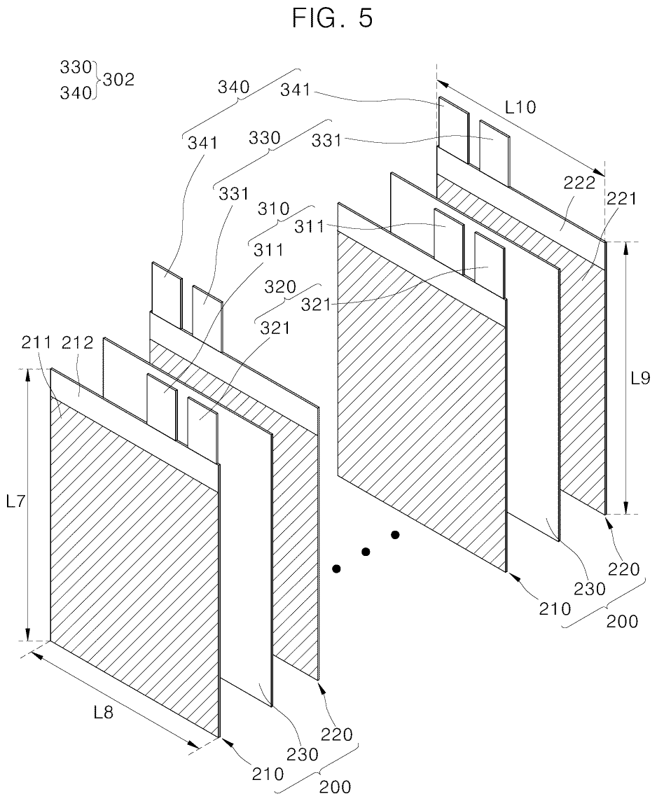

FIG. 5 is a view schematically illustrating a configuration of the electrode assembly according to one or more embodiments of the present disclosure.

Referring to FIGS. 2 to 5, the electrode assembly 200 according to one or more embodiments may have a shorter length L6 parallel to the second direction than a length L5 parallel to the first direction. That is, the length L5 of the electrode assembly 200 parallel to the first direction may be formed to be longer than the length L6 of the electrode assembly 200 parallel to the second direction.

The electrode assembly 200 may include a first electrode 210, a second electrode 220, and a separator 230 disposed between the first electrode 210 and the second electrode 220. A plurality of first electrodes 210, separators 230, and second electrodes 220 may be provided.

Hereinafter, the electrode assembly 200 will be described as having a stacked form in which a plurality of first electrodes 210, separators 230, and second electrodes 220 are sequentially stacked along the third direction (e.g., the x-axis direction). However, the form of the electrode assembly 200 may also be formed to have a form of being wound around a winding axis in a clockwise direction or in a counterclockwise direction in a state in which the first electrodes 210, the separators 230, and the second electrodes 220 are stacked.

The first electrode 210 may function as either a positive electrode or negative electrode of the electrode assembly 200. Hereinafter, the first electrode 210 will be described as an example of the positive electrode of the electrode assembly 200. However, the first electrode 210 is not limited thereto, and may also function as the negative electrode of the electrode assembly 200.

The first electrode 210 according to one or more embodiments may be formed to have a foil shape including a metal material such as aluminum or an aluminum alloy.

The type, size, shape, or the like of the first electrode 210 may vary, as long as it has conductivity and does not cause a chemical change in the secondary battery 20.

The first electrode 210 may have a shorter length L8 parallel to the second direction than a length L7 parallel to the first direction. That is, the length L7 of the first electrode 210 parallel to the first direction may be formed longer than the length L8 of the first electrode 210 parallel to the second direction.

A cross-sectional shape of the first electrode 210 may be designed to have various shapes in addition to the rectangular shape shown in FIG. 5.

A plurality of first electrodes 210 may be provided. The plurality of first electrodes 210 may be arranged between the front surface portion 120 and the rear surface portion 130 of the case 100 along the third direction. The number of first electrodes 210 may be designed to vary depending on the charging capacity and the like of the secondary battery 20.

A first active material layer 211 may be applied on at least a portion of the first electrode 210. The first active material layer 211 may be applied on both surfaces of the first electrode 210, or in other embodiments, may be applied on only one surface of the first electrode 210.

Since the first electrode 210 functions as the positive electrode in one or more embodiments, the first active material layer 211 may include a positive electrode active material.

The positive electrode active material may be a compound capable of reversibly intercalating and deintercalating lithium (a lithiated intercalation compound). More specifically, one or more types of a composite oxide of lithium and a metal selected from cobalt, manganese, nickel, iron, and a combination thereof may be used.

For example, the positive electrode active material may include at least one of lithium-iron-phosphorus oxide (LiFePO₄, LFP), lithium-manganese-iron-phosphorus oxide (LiMnFePO₄, LMFP), and lithium-nickel-cobalt-manganese oxide (LiNiₓCo_{y}Mn_{z}O₂, NCM). Here, 0<x<1, 0<y<1, 0<z<1, x+y+z=1 may be satisfied.

The positive electrode active material may include only one of lithium-iron-phosphorus oxide (LiFePO₄, LFP), lithium-manganese-iron-phosphorus oxide (LiMnFePO₄, LMFP), and lithium-nickel-cobalt-manganese oxide (LiNiₓCo_{y}Mn_{z}O₂, NCM), or may include two or all of lithium-iron-phosphorus oxide (LiFePO₄, LFP), lithium-manganese-iron-phosphorus oxide (LiMnFePO₄, LMFP), and lithium-nickel-cobalt-manganese oxide (LiNiₓCo_{y}Mn_{z}O₂, NCM).

The first active material layer 211 may further include a positive electrode conductive material.

The positive electrode conductive material is used to impart conductivity to the first active material layer 211, and any material which does not cause a chemical change and is electrically conductive may be used.

Examples of the positive electrode conductive material may include carbon-based materials such as natural graphite, artificial graphite, carbon black, acetylene black, Ketjen black, carbon fibers, carbon nanofibers, carbon nanotubes, metal-based materials in the form of metal powder or metal fibers containing copper, nickel, aluminum, silver, or the like, a conductive polymer such as a polyphenylene derivative, or the like, or a mixture thereof.

The first active material layer 211 may further include a positive electrode binder.

The positive electrode binder serves to attach the particles constituting the positive electrode active material to each other well, and also attach the positive electrode active material to the first electrode 210 well.

Examples of the positive electrode binder may include a non-aqueous binder, an aqueous binder, a dry binder, or a combination thereof.

The non-aqueous binder may include polyvinyl chloride, carboxylated polyvinyl chloride, polyvinyl fluoride, an ethylene propylene copolymer, polystyrene, polyurethane, polytetrafluoroethylene, polyvinylidene fluoride, polyethylene, polypropylene, polyamideimide, polyimide, or a combination thereof.

The aqueous binder may be selected from styrene-butadiene rubber, (meth)acrylated styrene-butadiene rubber, (meth)acrylonitrile-butadiene rubber, (meth)acrylic rubber, butyl rubber, a fluoroelastomer, polyethylene oxide, polyvinylpyrrolidone, polyepichlorohydrin, polyphosphazene, poly(meth)acrylonitrile, an ethylene propylene diene copolymer, polyvinyl pyridine, chlorosulfonated polyethylene, latex, polyester resin, (meth)acrylic resin, phenol resin, epoxy resin, polyvinyl alcohol, and a combination thereof.

When the aqueous binder is used as the positive electrode binder, a cellulose-based compound capable of imparting viscosity may be further included. As the cellulose-based compound, one or more types of carboxymethyl cellulose, hydroxypropylmethyl cellulose, methyl cellulose, or alkali metal salts thereof may be used in combination. Na, K, or Li may be used as the alkali metal.

The dry binder is a polymer material which may be fiberized and may be, for example, polytetrafluoroethylene, polyvinylidene fluoride, a polyvinylidene fluoride-hexafluoropropylene copolymer, polyethylene oxide, or a combination thereof.

The first electrode 210 may include a first uncoated portion 212 on which the first active material layer 211 is not applied.

The first uncoated portion 212 according to one or more embodiments may be disposed in an upper end region (in the orientation shown) of the first electrode 210 disposed to face the opening 160 in the case 100. However, the form of the first uncoated portion 212 may be formed over an entire edge region of the first electrode 210.

The second electrode 220 may function as either the positive electrode or the negative electrode of the electrode assembly 200. Hereinafter, the second electrode 220 will be described as an example of the negative electrode of the electrode assembly 200. However, the second electrode 220 may also function as the positive electrode of the electrode assembly 200.

A plurality of second electrodes 220 may be provided. The plurality of second electrodes 220 may be arranged between the front surface portion 120 and the rear surface portion 130 of the case 100 along the third direction.

The first electrodes 210 and the second electrodes 220 may be alternately disposed along the third direction. The second electrode 220 may be spaced apart from the first electrode 210 by a set interval along the third direction.

The second electrode 220 according to one or more embodiments may be formed to have a foil shape including a metal material such as copper, a copper alloy, nickel, or a nickel alloy.

The type, size, shape, or the like of the second electrode 220 may vary, as long it has conductivity and does not cause a chemical change in the secondary battery 20.

The second electrode 220 may have a shorter length L10 parallel to the second direction than a length L9 parallel to the first direction. That is, the length L9 of the second electrode 220 parallel to the first direction may be formed longer than the length L10 of the second electrode 220 parallel to the second direction.

A cross-sectional shape of the second electrode 220 may be designed to have various shapes in addition to the rectangular shape shown in FIG. 5.

A second active material layer 221 may be applied on at least a portion of the second electrode 220. The second active material layer 221 may be applied on both surfaces of the second electrode 220, or in other embodiments, may be applied on only one surface of the second electrode 220.

Since the second electrode 220 functions as the negative electrode, the second active material layer 221 may include a negative electrode active material.

The negative electrode active material may include a material capable of reversibly intercalating and deintercalating lithium ions, lithium metal, an alloy of lithium and a metal, a material capable of doping and dedoping lithium, or a transition metal oxide.

The material capable of reversibly intercalating and deintercalating lithium ions may include a carbon-based negative electrode active material, for example, crystalline carbon, amorphous carbon, or a combination thereof.

An example of crystalline carbon may be graphite such as amorphous, plate-shaped, flaky, spherical, or fibrous natural graphite or artificial graphite, and an example of amorphous carbon may be soft carbon or hard carbon, mesophase pitch carbide, calcined coke, or the like.

An alloy of lithium and a metal selected from Na, K, Rb, Cs, Fr, Be, Mg, Ca, Sr, Si, Sb, Pb, In, Zn, Ba, Ra, Ge, Al, and Sn may be used as the alloy of lithium and a metal.

A Si-based negative electrode active material or Sn-based negative electrode active material may be used as the material capable of doping and dedoping lithium. The Si-based negative electrode active material may be silicon, a silicon-carbon composite, SiOₓ (0<x<2), a Si-Q alloy (Q is selected from an alkali metal, an alkaline earth metal, a Group 13 element, a Group 14 element (excluding Si), a Group 15 element, a Group 16 element, a transition metal, a rare earth element, and a combination thereof), or a combination thereof. The Sn-based negative electrode active material may be Sn, SnO₂, a Sn-based alloy, or a combination thereof.

The silicon-carbon composite may be a composite of silicon and amorphous carbon. The silicon-carbon composite may be in the form of silicon particles whose surfaces are coated with amorphous carbon. For example, the silicon-carbon composite may include a secondary particle (a core) in which silicon primary particles are assembled, and an amorphous carbon coating layer (a shell) located on the surface of the secondary particle.

Amorphous carbon may also be located between the silicon primary particles, and for example, the silicon primary particles may be coated with amorphous carbon.

The secondary particles may be dispersed in an amorphous carbon matrix.

The silicon-carbon composite may further include crystalline carbon. For example, the silicon-carbon composite may include a core including crystalline carbon and silicon particles, and an amorphous carbon coating layer located on the surface of the core.

A Si-based negative electrode active material or a Sn-based negative electrode active material may be used in combination with a carbon-based negative electrode active material.

The second active material layer 221 may further include a negative electrode conductive material and a negative electrode binder.

The negative electrode conductive material is used to impart conductivity to the second active material layer 221, and any material which does not cause a chemical change and is electrically conductive may be used.

Examples of the negative electrode conductive material may include carbon-based materials such as natural graphite, artificial graphite, carbon black, acetylene black, Ketjen black, carbon fibers, carbon nanofibers, carbon nanotubes, or the like a metal-based material in the form of metal powder or metal fibers containing copper, nickel, aluminum, silver, or the like, a conductive polymer such as a polyphenylene derivative or the like, or a mixture thereof.

The negative electrode binder serves to attach the particles constituting the negative electrode active material to each other well, and also attach the negative electrode active material to the second electrode 220 well.

Examples of the negative electrode binders include a non-aqueous binder, an aqueous binder, a dry binder, or a combination thereof.

The non-aqueous binder may be polyvinyl chloride, carboxylated polyvinyl chloride, polyvinyl fluoride, an ethylene propylene copolymer, polystyrene, polyurethane, polytetrafluoroethylene, polyvinylidene fluoride, polyethylene, polypropylene, polyamideimide, polyimide, or a combination thereof.

The aqueous binder may be selected from styrene-butadiene rubber, (meth)acrylated styrene-butadiene rubber, (meth)acrylonitrile-butadiene rubber, (meth)acrylic rubber, butyl rubber, a fluoroelastomer, polyethylene oxide, polyvinylpyrrolidone, polyepichlorohydrin, polyphosphazene, poly(meth)acrylonitrile, an ethylene propylene diene copolymer, polyvinyl pyridine, chlorosulfonated polyethylene, latex, a polyester resin, a (meth)acrylic resin, a phenol resin, an epoxy resin, polyvinyl alcohol, and a combination thereof.

When the aqueous binder is used as the negative electrode binder, a cellulose-based compound capable of imparting viscosity may be further included. As the cellulose-based compound, one or more types of carboxymethyl cellulose, hydroxypropylmethyl cellulose, methyl cellulose or alkali metal salts thereof may be used in combination. As the alkali metal, Na, K, or Li may be used.

The dry binder is a polymer material which may be fiberized and may be, for example, polytetrafluoroethylene, polyvinylidene fluoride, a polyvinylidene fluoride-hexafluoropropylene copolymer, polyethylene oxide, or a combination thereof.

The second electrode 220 may include a second uncoated portion 222 on which the second active material layer 221 is not applied.

The second uncoated portion 222 according to one or more embodiments may be disposed in an upper end region (in the orientation shown) of the second electrode 220 disposed to face the opening 160 in the case 100. However, the second uncoated portion 222 may be formed over an entire edge region of the second electrode 220.

The separator 230 may be disposed between the first electrode 210 and the second electrode 220. The separator 230 may perform a function of preventing a short circuit between the first electrode 210 and the second electrode 220 while allowing lithium ions to move between the first electrode 210 and the second electrode 220.

The separator 230 may be disposed to entirely cover a surface region of the electrode assembly 200. Accordingly, the separator 230 may prevent the first electrode 210 and the second electrode 220 from being directly exposed to the outside of the electrode assembly 200.

As the separator 230, polyethylene, polypropylene, polyvinylidene fluoride, or a multilayer film of two or more layers thereof may be used, and a mixed multilayer film such as a polyethylene/polypropylene two-layer separator, a polyethylene/polypropylene/polyethylene three-layer separator, a polypropylene/polyethylene/polypropylene three-layer separator, or the like may be used.

The separator 230 may include a porous substrate and a coating layer containing an organic material, an inorganic material, or a combination thereof located on one surface or both surfaces of the porous substrate.

The porous substrate may be a polymer film formed of one polymer selected from polyolefins such as polyethylene and polypropylene, polyesters such as polyethylene terephthalate and polybutylene terephthalate, polyacetal, polyamide, polyimide, polycarbonate, polyether ketone, polyarylether ketone, polyetherimide, polyamideimide, polybenzimidazole, polyether sulfone, polyphenylene oxide, a cyclic olefin copolymer, polyphenylene sulfide, polyethylene naphthalate, glass fiber, polytetrafluoroethylene (PTFE) (e.g., Teflon), and polytetrafluoroethylene or a copolymer or mixture of two or more thereof.

The organic material may include a polyvinylidene fluoride polymer or a (meth)acrylic polymer.

The inorganic material may include inorganic particles selected from Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and a combination thereof, but other inorganic particles are possible.

The organic material and the inorganic material may be present as a mixture in one coating layer, or present in a form in which a coating layer containing an organic material and a coating layer containing an inorganic material are stacked.

The first tab member 301 (see FIG. 3) is connected to the first electrode 210 and may protrude outward from the electrode assembly 200. As the first electrode 210 is exemplified as the positive electrode, the first tab member 301 may function as a positive electrode tab of the secondary battery 20. However, the first tab member 301 may function as a negative electrode tab of the secondary battery 20 when the first electrode 210 is the negative electrode.

The first tab member 301 according to one or more embodiments may extend from the electrode assembly 200 in the first direction. That is, the first tab member 301 may extend toward the opening 160 from the inside of the case 100.

The first tab member 301 according to one or more embodiments may include a first inner tab member 310 and a first outer tab member 320.

The first inner tab member 310 and the first outer tab member 320 may be spaced apart from each other along the second direction. For example, the first outer tab member 320 and the first inner tab member 310 may be sequentially disposed along the second direction.

The first outer tab member 320 may be disposed at a position spaced apart from the first inner tab member 310 by a set interval in a direction opposite to the second direction. The first outer tab member 320 may be disposed at a position relatively closer to the first side surface portion 140 than the first inner tab member 310.

The first inner tab member 310 may include a first inner tab 311.

The first inner tab 311 according to one or more embodiments may have a foil shape extending from the first uncoated portion 212 of the first electrode 210 in the first direction.

The first inner tab 311 may have a substantially rectangular shape. However, the shape of the first inner tab 311 may be designed to have various shapes.

The first inner tab 311 may be formed integrally with the first electrode 210. For example, the first inner tab 311 may be the remaining region of the first uncoated portion 212 which remains after a partial region of the first uncoated portion 212 is cut or removed by notching processing or the like. In other embodiments, the first inner tab 311 may be manufactured separately from the first electrode 210 and then connected to the first uncoated portion 212 by welding or the like. A material of the first inner tab 311 may be the same as a material of the first electrode 210.

A plurality of first inner tabs 311 may be provided. The number of first inner tabs 311 may be the same as the number of first electrodes 210. Each first inner tab 311 may individually extend from the first uncoated portions 212 of different first electrodes 210.

Neighboring first inner tabs 311 may be disposed to face each other along the third direction. The neighboring first inner tabs 311 may be disposed parallel to each other. Accordingly, the first inner tab member 310 according to one or more embodiments may be an assembly of the plurality of first inner tabs 311 stacked along the third direction.

The neighboring first inner tabs 311 may be in contact (e.g., in direct contact) with each other and may also be spaced apart from each other by a thickness of the separator 230.

The first outer tab member 320 may include a first outer tab 321.

The first outer tab 321 according to one or more embodiments may have a foil shape extending from the first uncoated portion 212 of the first electrode 210 in the first direction.

The first outer tab 321 may be disposed at a position spaced apart from the first inner tab 311 by a set interval in the direction opposite to the second direction.

The first outer tab 321 may have a substantially rectangular shape. However, the shape of the first outer tab 321 may be designed to have various shapes.

The first outer tab 321 may be formed integrally with the first electrode 210. For example, the first outer tab 321 may be a region excluding the first inner tab 311 among the remaining region of the first uncoated portion 212 which remains after the partial region of the first uncoated portion 212 is cut or removed by notching processing or the like. Alternatively, the outer tab 321 may be manufactured separately from the first electrode 210 and then connected to the first uncoated portion 212 by welding or the like. A material of the first outer tab 321 may be the same as the material of the first electrode 210.

A plurality of first outer tabs 321 may be provided. The number of first outer tabs 321 may be the same as the number of first electrodes 210. Each first outer tab 321 may individually extend from the first uncoated portions 212 of different first electrodes 210.

Neighboring first outer tabs 321 may be disposed to face each other along the third direction. The neighboring first outer tabs 321 may be disposed parallel to each other. Accordingly, the first outer tab member 320 according to one or more embodiments may be an assembly of the plurality of first outer tabs 321 stacked along the third direction.

The neighboring first outer tabs 321 may be in contact (e.g., in direct contact) with each other and may also be spaced apart from each other by the thickness of the separator 230.

The secondary battery 20 according to one or more embodiments may further include a second tab member 302 (see FIG. 5).

The second tab member 302 is connected to the second electrode 220 and may protrude outward from the electrode assembly 200.

As the second electrode 220 is exemplified as the negative electrode, the second tab member 302 may function as the negative electrode tab of the secondary battery 20. However, the second tab member 302 may function as the positive electrode tab of the secondary battery 20 when the second electrode 220 is the positive electrode.

The second tab member 302 according to one or more embodiments may extend from the electrode assembly 200 in the first direction. That is, the second tab member 302 may extend toward the opening 160 from the inside of the case 100.

The first tab member 301 and the second tab member 302 may be disposed to be spaced apart from each other along the second direction. For example, the second tab member 302 may be disposed at a position spaced apart from the first tab member 301 by a set interval along the second direction.

The second tab member 302 according to one or more embodiments may include a second inner tab member 330 and a second outer tab member 340.

The second inner tab member 330 and the second outer tab member 340 may be spaced apart from each other along the second direction. For example, the second inner tab member 330 and the second outer tab member 340 may be sequentially disposed along the second direction.

The second outer tab member 340 may be disposed at a position spaced apart from the second inner tab member 330 by a set interval in the second direction. The second outer tab member 340 may be disposed at a position relatively closer to the second side surface portion 150 than the second inner tab member 330.

The second inner tab member 330 may include a second inner tab 331.

The second inner tab 331 according to one or more embodiments may have a foil shape extending from the second uncoated portion 222 of the second electrode 220 in the first direction.

The second inner tab 331 may have a substantially rectangular shape. However, the shape of the second inner tab 331 may be designed to have various shapes.

The second inner tab 331 may be formed integrally with the second electrode 220. For example, the second inner tab 331 may be the remaining region of the second uncoated portion 222 which remains after a partial region of the second uncoated portion 222 is cut or removed by notching processing or the like. In other embodiments, the second inner tab 331 may be manufactured separately from the second electrode 220 and then connected to the second uncoated portion 222 by welding or the like. A material of the second inner tab 331 may be the same as a material of the second electrode 220.

A plurality of second inner tabs 331 may be provided. The number of second inner tabs 331 may be the same as the number of second electrodes 220. Each second inner tab 331 may individually extend from the second uncoated portions 222 of different second electrodes 220.

Neighboring second inner tabs 331 may be disposed to face each other along the third direction. The neighboring second inner tabs 331 may be disposed parallel to each other. Accordingly, the second inner tab member 330 according to one or more embodiments may be an assembly of the plurality of second inner tabs 331 stacked along the third direction.

The neighboring second inner tabs 331 may be in contact (e.g., in direct contact) with each other and may also be spaced apart from each other by the thickness of the separator 230.

The second outer tab member 340 may include a second outer tab 341.

The second outer tab 341 according to one or more embodiments may have a foil shape extending from the second uncoated portion 222 of the second electrode 220 in the first direction.

The second outer tab 341 may be disposed at a position spaced apart from the second inner tab 331 by a set interval in the second direction.

The second outer tab 341 may have a substantially rectangular shape. However, the shape of the second outer tab 341 may be designed to have various shapes.

The second outer tab 341 may be formed integrally with the second electrode 220. For example, the second outer tab 341 may be a region excluding the second inner tab 331 among the remaining region of the second uncoated portion 222 which remains after the partial region of the second uncoated portion 222 is cut or removed by notching processing or the like. In other embodiments, the second outer tab 341 may be manufactured separately from the second electrode 220 and then connected to the second uncoated portion 222 by welding or the like. A material of the second outer tab 341 may be the same as the material of the second electrode 220.

A plurality of second outer tabs 341 may be provided. The number of second outer tabs 341 may be the same as the number of second electrodes 220. Each second outer tab 341 may individually extend from the second uncoated portions 222 of different second electrodes 220.

Neighboring second outer tabs 341 may be disposed to face each other along the third direction. The neighboring second outer tabs 341 may be disposed parallel to each other. Accordingly, the second outer tab member 340 according to one or more embodiments may be an assembly of the plurality of second outer tabs 341 stacked along the third direction.

The neighboring second outer tabs 341 may be in contact with each other and may also be spaced apart from each other by the thickness of the separator 230.

The cap assembly 400 is coupled to the case 100 and may seal the case 100. The cap assembly 400 may be disposed to face the electrode assembly 200 along the first direction.

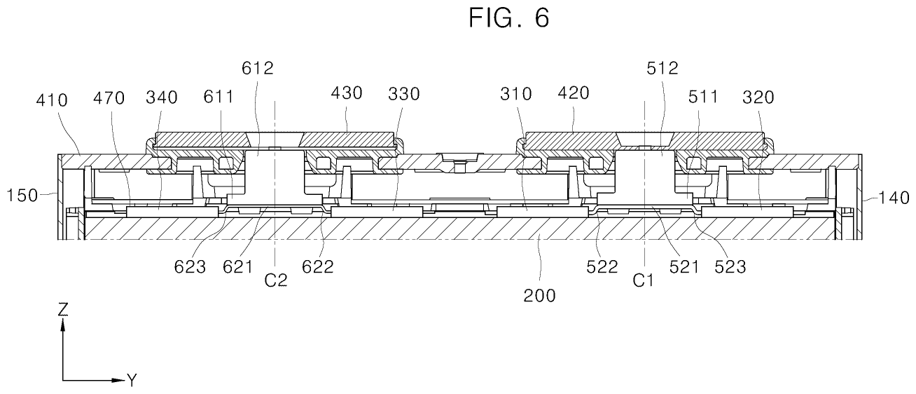

FIG. 6 is an enlarged cross-sectional view schematically illustrating a configuration of the cap assembly according to one or more embodiments of the present disclosure.

Referring to FIGS. 2 to 6, the cap assembly 400 according to one or more embodiments may include a cap plate 410, a first terminal 420, and a second terminal 430.

The cap plate 410 forms an approximate exterior of the cap assembly 400 and may entirely support the first terminal 420 and the second terminal 430.

The cap plate 410 according to one or more embodiments may be formed to have a flat plate shape. The cap plate 410 may be disposed in the opening 160 of the case 100. The cap plate 410 may be disposed to face the electrode assembly 200 along the first direction.

The cap plate 410 may be disposed at a position spaced apart from the electrode assembly 200 by a set distance in the first direction. The cap plate 410 may be disposed parallel to the bottom portion 110 of the case 100.

The cap plate 410 may be seated on an upper end portion of the case 100 (in the orientation shown), more specifically, on the upper end portions of the front surface portion 120, the rear surface portion 130, the first side surface portion 140, and the second side surface portion 150. The cap plate 410 may be coupled to the case 100 by various types of coupling methods such as welding, bolting, fitting, and the like.

The first terminal 420 may protrude outward from the cap plate 410. The first terminal 420 may be electrically connected to the first electrode 210. Since the first electrode 210 according to one or more embodiments functions as a positive electrode, the first terminal 420 may be exemplified as a positive electrode terminal of the secondary battery 20.

The first terminal 420 according to one or more embodiments may be inserted into the cap plate 410. An upper end portion of the first terminal 420 may protrude from the cap plate 410 in the first direction.

FIG. 3 illustrates an example in which the first terminal 420 has a rectangular cross-sectional shape, but the cross-sectional shape of the first terminal 420 may be designed to have various shapes such as a circular shape, an oval shape, a polygonal shape, and the like. The first terminal 420 may be formed of an electrically conductive material such as aluminum, nickel, copper, or the like.

A first terminal axis C1 (see FIG. 6) passing through a central portion of the first terminal 420 in the first direction may be disposed between the first inner tab member 310 and the first outer tab member 320.

A first gasket 421 (see FIG. 3) may be installed between the cap plate 410 and the first terminal 420. The first gasket 421 may electrically insulate the cap plate 410 and the first terminal 420 and prevent moisture or foreign substances from entering between the cap plate 410 and the first terminal 420.

The first gasket 421 according to one or more embodiments may be formed of an insulating material such as polyethylene (PE), polypropylene (PP), polyethylene terephthalate (PET) rubber, or the like. The first gasket 421 may be fixed between the cap plate 410 and the first terminal 420 by pressing, injection, adhesion, or the like.

The second terminal 430 may protrude outward from the cap plate 410 at a position spaced apart from the first terminal 420. The second terminal 430 may be electrically connected to the second electrode 220. Since the second electrode 220 according to one or more embodiments functions as a negative electrode, the second terminal 430 may be exemplified as a negative electrode terminal of the secondary battery 20.

The second terminal 430 according to one or more embodiments may be inserted into the cap plate 410. An upper end portion of the second terminal 430 may protrude from the cap plate 410 in the first direction.

FIG. 3 illustrates an example in which the second terminal 430 has a rectangular cross-sectional shape, but the cross-sectional shape of the second terminal 430 may be designed to have various shapes such as a circular shape, an oval shape, a polygonal shape, and the like. The second terminal 430 may be formed of an electrically conductive material such as aluminum, nickel, copper, or the like.

The second terminal 430 may be disposed at a position spaced apart from the first terminal 420 by a set distance along the second direction. A second terminal axis C2 (see FIG. 6) passing through a central portion of the second terminal 430 in the first direction may be disposed between the second inner tab member 330 and the second outer tab member 340.

A second gasket 431 may be installed between the cap plate 410 and the second terminal 430. The second gasket 431 may electrically insulate the cap plate 410 and the second terminal 430 and prevent moisture or foreign substances from entering between the cap plate 410 and the second terminal 430.

The second gasket 431 according to one or more embodiments may be formed of an insulating material such as polyethylene (PE), polypropylene (PP), polyethylene terephthalate (PET) rubber, or the like. The second gasket 431 may be fixed between the cap plate 410 and the second terminal 430 by pressing, injection, adhesion, or the like.

The cap assembly 400 according to one or more embodiments may further include an electrolyte inlet 460 formed to pass through the cap plate 410 and in which a sealing stopper may be installed.

The electrolyte inlet 460 may be disposed between the first terminal 420 and the second terminal 430.

The cap assembly 400 according to one or more embodiments may further include an insulating plate 470 (see FIG. 6).

The insulating plate 470 may be disposed between the cap plate 410 and the electrode assembly 200. The insulating plate 470 may prevent direct contact between the cap plate 410 and the electrode assembly 200 to insulate the cap plate 410 and the electrode assembly 200.

The insulating plate 470 may fix the position of the electrode assembly 200 in the case 100. The insulating plate 470 may prevent the electrode assembly 200 from being damaged when the cap plate 410 is deformed toward the inside of the case 100 due to an external impact or the like.

The insulating plate 470 according to one or more embodiments may be disposed to face the electrode assembly 200 in the case 100 along the first direction. The electrode assembly 200, the insulating plate 470, and the cap plate 410 may be sequentially disposed along the first direction.

The insulating plate 470 may be fixed to an inner side surface of the case 100 by various types of coupling methods such as fitting, welding, bolting, adhesion, and the like.

The insulating plate 470 may be in contact with one surface of the electrode assembly 200 from which the first tab member 301 and the second tab member 302 extend. The insulating plate 470 may be formed of an insulating material such as polyethylene (PE), polypropylene (PP), polyethylene terephthalate (PET) rubber, or the like.

The first connection member 500 (see FIG. 3) may be disposed between the electrode assembly 200 and the cap assembly 400. The first connection member 500 may be connected to the first terminal 420 and the first tab member 301.

The first connection member 500 may function as a configuration that electrically connects the first terminal 420 and the first tab member 301. The first connection member 500 may be formed of a material which is electrically conductive.

The first connection member 500 may be formed of the same material as the first terminal 420.

The first connection member 500 according to one or more embodiments may include a first current collector 510 and a first current collector plate 520.

The first current collector 510 may be connected to the first terminal 420.

The first current collector 510 according to one or more embodiments may include a first body 511 and a first boss 512.

The first body 511 may form the exterior of one side of the first current collector 510 and support the first boss 512.

The first body 511 according to one or more embodiments may be disposed between the electrode assembly 200 and the first terminal 420. The first terminal axis C1 may pass through a central portion of the first body 511.

The first body 511 may be disposed in the insulating plate 470, or in other embodiments, may also be disposed at an upper or lower side of the insulating plate 470. A cross-sectional shape of the first body 511 may be designed to have various shapes such as a circular shape, an oval shape, a polygonal shape, and the like in addition to the quadrangular shape shown in FIG. 3

The first boss 512 may extend from the first body 511 and may be connected to the first terminal 420.

The first boss 512 according to one or more embodiments may have a cylindrical shape extending from the first body 511 in the first direction. A central axis of the first boss 512 may be disposed coaxially with the first terminal axis C1.

An upper end surface of the first boss 512 may be in contact with a lower surface of the first terminal 420. In this case, the first boss 512 may vertically pass through the insulating plate 470 in the first direction.

The upper end surface of the first boss 512 may be joined to the lower surface of the first terminal 420 by laser welding. A cross-sectional shape of the first boss 512 may be designed to have various shapes such as an oval shape, a polygonal shape, and the like in addition to the circular shape shown in FIG. 3

The first current collector plate 520 may be fixed to the first current collector 510 and connected to the first tab member 301.

The first current collector plate 520 according to one or more embodiments may include a first center plate 521, a first inner plate 522, and a first outer plate 523.

The first center plate 521 may form the exterior of the center of the first current collector plate 520 and may be connected to the first current collector 510.

The first center plate 521 according to one or more embodiments may be disposed between the first body 511 and the electrode assembly 200. The first center plate 521 may be in contact with a lower surface of the first body 511 located at an opposite side of the first boss 512.

The first center plate 521 may be fixed to the lower surface of the first body 511 by various types of coupling methods such as welding, bolting, adhesion, and the like.

Both end portions of the first center plate 521 may extend toward the electrode assembly 200 from the first body 511. Both end portions of the first center plate 521 may pass through the insulating plate 470 and may be disposed at the lower side of the insulating plate 470.

The first inner plate 522 may extend from the first current collector 510 in the second direction.

The first inner plate 522 according to one or more embodiments may extend from one end portion of the first center plate 521 in the second direction. The first inner plate 522 may be disposed to face the first inner tab member 310 along the first direction. The first inner plate 522 may be in contact with an end surface of the first inner tab member 310.

The first inner tab member 310 and the first inner plate 522 may be joined by laser welding.

The first outer plate 523 may extend from the first current collector 510 in the direction opposite to the second direction.

The first outer plate 523 according to one or more embodiments may extend from the other end portion of the first center plate 521 in the direction opposite to the second direction. The first outer plate 523 may be disposed to face the first outer tab member 320 along the first direction. The first outer plate 523 may be in contact with an end surface of the first outer tab member 320.

The first outer tab member 320 and the first outer plate 523 may be joined by laser welding.

The first connection member 500 may be formed symmetrically with respect to the first terminal axis C1. A length of one side of the first connection member 500 extending in the second direction based on the first terminal axis C1 and a length of the other side of the first connection member 500 extending in the direction opposite to the second direction may be the same. A length of the first inner plate 522 parallel to the second direction and a length of the first outer plate 523 parallel to the second direction may be the same.

A length of the first inner tab member 310 may be the same as the length of the first inner plate 522, and a length of the first outer tab member 320 may be the same as the length of the first outer plate 523. However, the length of the first inner tab member 310 and the length of the first outer tab member 320 may not be the same.

The secondary battery 20 according to one or more embodiments may further include a second connection member 600.

The second connection member 600 may be disposed between the electrode assembly 200 and the cap assembly 400. The second connection member 600 may be connected to the second terminal 430 and the second tab member 302.

The second connection member 600 may function as a configuration that electrically connects the second terminal 430 and the second tab member 302. The second connection member 600 may be formed of a material which is electrically conductive. The second connection member 600 may be formed of the same material as the second terminal 430.

The second connection member 600 according to one or more embodiments may include a second current collector 610 and a second current collector plate 620.

The second current collector 610 may be connected to the second terminal 430.

The second current collector 610 according to one or more embodiments may include a second body 611 and a second boss 612.

The second body 611 may form the exterior of one side of the second current collector 610 and support the second boss 612.

The second body 611 according to one or more embodiments may be disposed between the electrode assembly 200 and the second terminal 430. The second terminal axis C2 may pass through a central portion of the second body 611.

The second body 611 may be disposed in the insulating plate 470, or in other embodiments, may also be disposed at an upper or lower side of the insulating plate 470. A cross-sectional shape of the second body 611 may be designed to have various shapes such as a circular shape, an oval shape, a polygonal shape, and the like in addition to the quadrangular shape shown in FIG. 3

The second boss 612 may extend from the second body 611 and may be connected to the second terminal 430.

The second boss 612 according to one or more embodiments may have a cylindrical shape extending from the second body 611 in the first direction. A central axis of the second boss 612 may be disposed coaxially with the second terminal axis C2.

An upper end surface of the second boss 612 may be in contact with a lower surface of the second terminal 430. In this case, the second boss 612 may vertically pass through the insulating plate 470 in the first direction.

The upper end surface of the second boss 612 may be joined to the lower surface of the second terminal 430 by laser welding. A cross-sectional shape of the second boss 612 may be designed to have various shapes such as an oval shape, a polygonal shape, and the like in addition to the circular shape shown in FIG. 3

The second current collector plate 620 may be fixed to the second current collector 610 and connected to the second tab member 302.

The second current collector plate 620 according to one or more embodiments may include a second center plate 621, a second inner plate 622, and a second outer plate 623.

The second center plate 621 may form the exterior of the center of the second current collector plate 620 and may be connected to the second current collector 610.

The second center plate 621 according to one or more embodiments may be disposed between the second body 611 and the electrode assembly 200. The second center plate 621 may be in contact with a lower surface of the second body 611 located at an opposite side of the second boss 612.

The second center plate 621 may be fixed to the lower surface of the second body 611 by various types of coupling methods such as welding, bolting, adhesion, and the like.

Both end portions of the second center plate 621 may extend toward the electrode assembly 200 from the second body 611. Both end portions of the second center plate 621 may pass through the insulating plate 470 and may be disposed at the lower side of the insulating plate 470.

The second inner plate 622 may extend from the second current collector 610 in the direction opposite to the second direction.

The second inner plate 622 according to one or more embodiments may extend from one end portion of the second center plate 621 in the direction opposite to the second direction.

The second inner plate 622 may be disposed to face the second inner tab member 330 along the first direction. The second inner plate 622 may be in contact with an end surface of the second inner tab member 330.

The second inner tab member 330 and the second inner plate 622 may be joined by laser welding.

The second outer plate 623 may extend from the second current collector 610 in the second direction.

The second outer plate 623 according to one or more embodiments may extend from the other end portion of the second center plate 621 in the second direction. The second outer plate 623 may be disposed to face the second outer tab member 340 along the first direction. The second outer plate 623 may be in contact with an end surface of the second outer tab member 340.

The second outer tab member 340 and the second outer plate 623 may be joined by laser welding.

The second connection member 600 may be formed symmetrically with respect to the second terminal axis C2. A length of one side of the second connection member 600 extending in the second direction based on the second terminal axis C2 and a length of the other side of the second connection member 600 extending in the direction opposite to the second direction may be the same. A length of the second inner plate 622 parallel to the second direction and a length of the second outer plate 623 parallel to the second direction may be the same.

The length of the first inner tab member 310 parallel to the second direction and the length of the first outer tab member 320 parallel to the second direction may be the same. The length of the first inner tab member 310 may be the same as the length of the second inner plate 622, and the length of the first outer tab member 320 may be the same as the length of the second outer plate 623. However, the length of the first inner tab member 310 and the length of the first outer tab member 320 may not be the same.

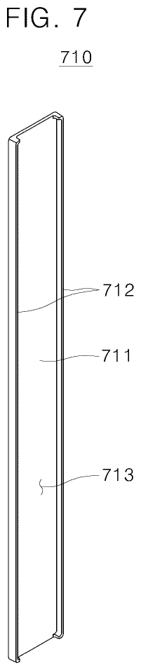

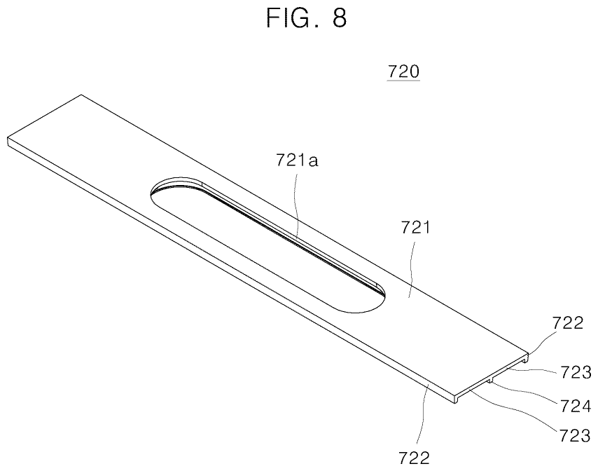

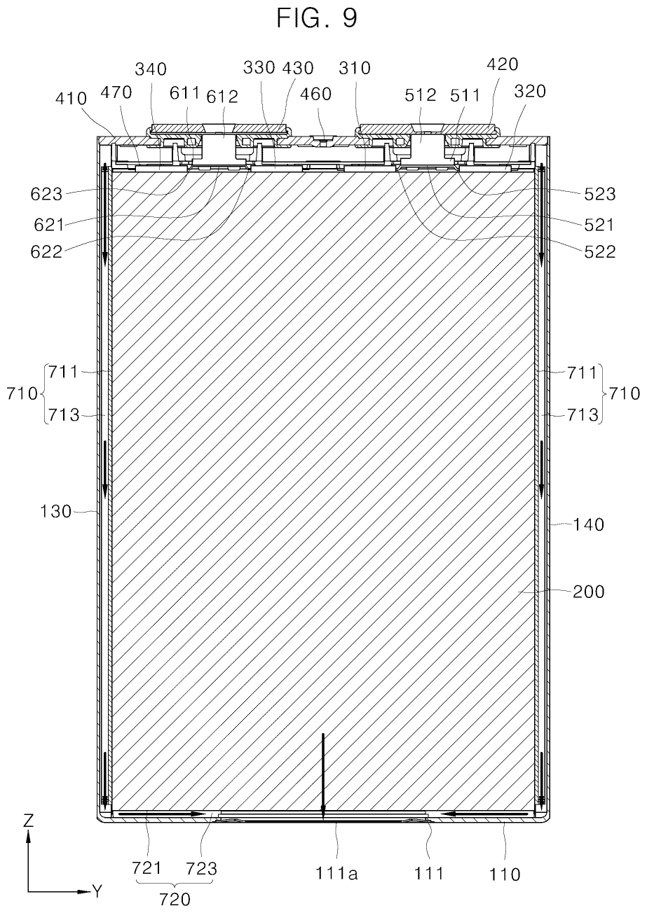

FIG. 7 is a perspective view schematically illustrating a configuration of a first guide portion according to one or more embodiments of the present disclosure, FIG. 8 is a perspective view schematically illustrating a configuration of a second guide portion according to one or more embodiments of the present disclosure, and FIG. 9 is a cross-sectional view schematically illustrating a flow of gas in the secondary battery according to one or more embodiments of the present disclosure.

Referring to FIGS. 2 to 9, the secondary battery 20 according to one or more embodiments may further include a guide portion 700.

The guide portion 700 may be disposed between the case 100 and the electrode assembly 200. The guide portion 700 may guide a flow of gas toward the vent 111a. The guide portion 700 may guide the flow of gas toward the vent 111a provided in the bottom portion 110 of the case 100 so that gas generated inside the case 100 due to internal deterioration of the secondary battery 20 is discharged through the vent 111a.

The guide portion 700 according to one or more embodiments may include a first guide portion 710 and a second guide portion 720.

The first guide portion 710 may be disposed (e.g., may extend lengthwise) in the first direction. A pair of first guide portions 710 may be provided. The pair of first guide portions 710 may be disposed at both sides of the electrode assembly 200.

One first guide portion 710 may be vertically disposed in the first direction between one side of the electrode assembly 200 and the first side surface portion 140 of the case 100, and the other first guide portion 710 may be vertically disposed in the first direction between the other side of the electrode assembly 200 and the second side surface portion 150 of the case 100.

The first guide portion 710 may include a first guide plate 711, a first guide side wall 712, and a first guide flow path 713.

The first guide plate 711 may be formed in a rectangular plate shape having a set length. The first guide plate 711 may be attached to an outer side surface of the electrode assembly 200 facing the inner side surface of the case 100. The first guide plate 711 may be spaced apart from the inner side surface of the case 100.

The first guide side wall 712 may extend from the first guide plate 711. A pair of first guide side walls 712 may be provided. The pair of first guide side walls 712 may extend from a long side edge of the first guide plate 711 to the inner side surface of the case 100. The pair of first guide side walls 712 may be disposed to be spaced apart and face each other. An end portion of the first guide side wall 712 may be in contact with the inner side surface of the case 100.

The first guide flow path 713 may be formed between the pair of first guide side walls 712. Gas may flow through the first guide flow path 713. The first guide flow path 713 may be formed in a direction from where the opening 160 of the case 100 is located to where the bottom portion 110 of the case 100 is located. Arrows shown in FIG. 9 indicate the direction in which gas flows.

The second guide portion 720 may be disposed (e.g., may extend width wise) in the second direction. The second guide portion 720 may be disposed to intersect the first guide portion 710. The second guide portion 720 may be disposed between the pair of first guide portions 710.

The second guide portion 720 may be disposed to face the vent 111a. The second guide portion 720 may be disposed between a lower surface of the electrode assembly 200 and the bottom portion 110 of the case 100. The bottom portion 110 of the case 100 and a lower portion of the electrode assembly 200 may be spaced apart from each other by the second guide portion 720 to prevent interference between the vent 111a provided in the bottom portion 110 and the electrode assembly 200. Both end portions of the second guide portion 720 may be respectively spaced apart from or connected to one side end portions of the pair of first guide portions 710.

The second guide portion 720 may include a second guide plate 721, a second guide side wall 722, and a second guide flow path 723.

The second guide plate 721 may be formed in a rectangular plate shape having a set length. The lower portion of the electrode assembly 200 may be seated on the second guide plate 721. The second guide plate 721 may be in contact with the lower surface of the electrode assembly 200. The second guide plate 721 may be spaced apart from the bottom portion 110 of the case 100.

The second guide side wall 722 may extend from the second guide plate 721. A pair of second guide side walls 722 may be provided. The pair of second guide side walls 722 may extend from a long side edge of the second guide plate 721 to the bottom portion 110 of the case 100. The pair of second guide side walls 722 may be disposed to be spaced apart and face each other. An end portion of the second guide side wall 722 may be in contact with the bottom portion 110 of the case 100.

The second guide flow path 723 may be formed between the pair of second guide side walls 722. Gas may flow through the second guide flow path 723. Gas flowing through the first guide flow path 713 may be introduced into the second guide flow path 723, guided to the vent 111a through the second guide flow path 723, and discharged to the outside of the case 100 through the vent 111a. The arrows shown in FIG. 9 indicate the direction in which gas flows.

A through hole portion 721a may be further provided in the second guide plate 721 according to one or more embodiments. The through hole portion 721a may be formed to have a hole shape (an elongated oval shape in FIG. 8) vertically passing through both surfaces of the second guide plate 721 in the first direction. The through hole portion 721a may be disposed to face the vent 111a and communicate with the vent 111a.

Gas that is not guided by the guide portion 700 may pass through the through hole portion 721a and may be discharged to the outside of the case 100 through the vent 111a.

The second guide portion 720 according to one or more embodiments may further include a reinforcement rib 724.

The reinforcement rib 724 may extend from the second guide plate 721. The reinforcement rib 724 may be disposed between the pair of second guide side walls 722 and extend to the bottom portion 110 of the case 100. An end portion of the reinforcement rib 724 may be in contact with the bottom portion 110 of the case 100.

The reinforcement rib 724 may prevent deformation of the second guide portion 720 due to the load of the electrode assembly 200.

A plurality of secondary batteries 20 may be provided. The plurality of secondary batteries 20 may be arranged in two or more rows along at least one of the longitudinal direction (the X-axis direction based on FIG. 1) and the width direction (the Y-axis direction based on FIG. 1) of the housing 10.

FIG. 1 illustrates that the plurality of secondary batteries 20 are arranged in six rows along the longitudinal direction of the housing 10, but the arrangement of the plurality of secondary batteries 20 may be designed to have various arrangements.

The plurality of secondary batteries 20 may be disposed in parallel. The number of secondary batteries 20 may be designed in various ways depending on the size, shape, and the like of the housing 10.

The first terminal 420 of one secondary battery 20 among a pair of neighboring secondary batteries 20 and the second terminal 430 of the other of the neighboring secondary batteries 20 may be disposed to face each other along the longitudinal direction of the housing 10.

The front surface portion 120 of one of the neighboring secondary batteries 20 may be disposed to face the rear surface portion 130 of the other of the neighboring secondary batteries 20.

The plurality of secondary batteries 20 may be electrically connected by a bus bar 30.

The bus bar 30 according to one or more embodiments may be disposed between the cover 12 and the secondary battery 20. A plurality of bus bars 30 may be provided. Each bus bar 30 may connect the pair of neighboring secondary batteries 20 in series or parallel.

Both sides of the bus bar 30 may be respectively connected to the first terminal 420 of one of the pair of neighboring secondary batteries 20 and the second terminal 430 of the other secondary battery 20. Accordingly, the plurality of secondary batteries 20 may be connected to each other in series by the bus bar 30.

However, the bus bar 30 may also be respectively connected to the first terminal 420 of one of the pair of neighboring secondary batteries 20 and the first terminal 420 of the other secondary battery 20 or respectively connected to the second terminal 430 of one of the pair of neighboring secondary batteries 20 and the second terminal 430 of the other secondary battery 20.

The bus bar 30 may be formed of an electrically conductive material such as copper, aluminum, nickel, or the like. A specific shape of the bus bar 30 is not limited to that shown in FIG. 1, and may be designed to have various shapes capable of electrically connecting neighboring secondary batteries 20.

The plurality of bus bar 30 may be supported in the housing 10 by a bus bar holder 40.

The bus bar holder 40 according to one or more embodiments may be formed to have a flat plate shape. The bus bar holder 40 may be disposed between the cover 12 and the secondary battery 20.

The bus bar 30 may be fixed to the bus bar holder 40 by various types of coupling methods such as fitting, bolting, injection coupling, and the like. The bus bar holder 40 may be configured to include an electrically insulating polymer compound material.

According to one or more embodiments of the present disclosure, lengths of a front surface portion, a rear surface portion, a first side surface portion, and a second side surface portion of a case are longer than a length of a bottom portion of the case, and a vent can be provided in the bottom portion to increase space utilization of a secondary battery.

According to one or more embodiments of the present disclosure, as gas generated due to internal deterioration of the secondary battery is guided to flow to the bottom portion of the case where a vent is located by a guide portion disposed between the case and the electrode assembly, the gas can be smoothly discharged to the outside of the case through the vent.

However, the effects obtainable through the present disclosure are not limited to the above effects, and other technical effects that are not mentioned will be clearly understood by those skilled in the art from the preceding description of the present disclosure.

While the present disclosure has been described with reference to some example embodiments shown in the drawings, these embodiments are merely illustrative and it is to be understood that various modifications and equivalent other embodiments can be derived by those skilled in the art on the basis of one or more embodiments. Therefore, the technical scope of the present disclosure should be defined by the claims.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. An electrode assembly, comprising:
a first electrode;
a second electrode facing the first electrode;
a first tab member extending from the first electrode; and
a second tab member extending from the second electrode,
wherein the first electrode and the second electrode have shorter lengths parallel to a second direction intersecting a first direction than lengths parallel to the first direction.

2. The electrode assembly as claimed in claim 1, wherein:
the first tab member extends from the first electrode in the first direction; and
the second tab member extends from the second electrode in the first direction.

3. The electrode assembly as claimed in claim 2, wherein the first tab member and the second tab member are spaced apart from each other along the second direction.

4. A secondary battery, comprising:
a case including a vent;
an electrode assembly accommodated in the case, the electrode assembly including a first tab member and a second tab member extending in a first direction;
a cap assembly facing the electrode assembly along the first direction, the cap assembly including a first terminal and a second terminal; and
a first connection member between the electrode assembly and the cap assembly, the first connection member connected to the first terminal and the first tab member,
wherein the electrode assembly has a shorter length parallel to a second direction intersecting a first direction than a length parallel to the first direction.

5. The secondary battery as claimed in claim 4, wherein the case has a shorter length parallel to the second direction than a length parallel to the first direction.

6. The secondary battery as claimed in claim 5, further comprising a guide portion between the case and the electrode assembly, the guide portion guiding a flow of gas toward the vent.

7. The secondary battery as claimed in claim 6, wherein the guide portion includes:
first guide portions in the first direction; and
a second guide portion in the second direction.

8. The secondary battery as claimed in claim 7, wherein:
the first guide portions are at both sides of the electrode assembly; and
the second guide portion faces the vent.

9. The secondary battery as claimed in claim 8, wherein each of the first guide portions includes:
a first guide plate in contact with a side surface of the electrode assembly; and
a pair of first guide side walls extending from the first guide plate, spaced apart from and facing each other, the pair of first guide side walls contacting the case.

10. The secondary battery as claimed in claim 9, wherein:
the first guide portion further includes a first guide flow path between the pair of first guide side walls, and
gas flows through the first guide flow path.

11. The secondary battery as claimed in claim 8, wherein the second guide portion includes:
a second guide plate in contact with a lower surface of the electrode assembly; and
a pair of second guide side walls extending from the second guide plate, spaced apart from and facing each other, the pair of second guide side walls contacting the case.

12. The secondary battery as claimed in claim 11, wherein:
the second guide portion further includes a second guide flow path between the pair of second guide side walls, and
gas flows through the second guide flow path.

13. The secondary battery as claimed in claim 11, wherein a through hole portion that communicates with the vent is in the second guide plate.

14. The secondary battery as claimed in claim 11, wherein the second guide portion further includes a reinforcement rib extending from the second guide plate, the reinforcement rib being between the pair of second guide side walls and in contact with the case.

15. The secondary battery as claimed in claim 5, wherein the first connection member includes:
a first current collector connected to the first terminal;
a first inner plate extending from the first current collector in the second direction; and
a first outer plate extending from the first current collector in a direction opposite to the second direction.

16. The secondary battery as claimed in claim 15, wherein the first tab member includes:
a first inner tab member connected to the first inner plate; and
a first outer tab member spaced apart from the first inner tab member in the direction opposite to the second direction, the first outer tab member being connected to the first outer plate.

17. The secondary battery as claimed in claim 5, further comprising a second connection member between the electrode assembly and the cap assembly, the second connection member being connected to the second terminal and the second tab member.

18. The secondary battery as claimed in claim 17, wherein the second connection member includes:
a second current collector connected to the second terminal;
a second inner plate extending from the second current collector in a direction opposite to the second direction; and
a second outer plate extending from the second current collector in the second direction.

19. The secondary battery as claimed in claim 5, wherein the first terminal and the second terminal are spaced apart from each other along the second direction.

20. A battery pack, comprising:
a housing; and
a plurality of secondary batteries disposed in the housing,
wherein each of the plurality of secondary batteries has a shorter length parallel to a second direction intersecting a first direction than a length parallel to the first direction.
